(19) United States
(12) Patent Application Publication
(10) Pub. No.: US 2015/0287208 A1
(43) Pub. Date: Oct. 8, 2015

(54) IMAGE PROCESSING APPARATUS, IMAGE PICKUP APPARATUS, IMAGE PROCESSING METHOD, AND NON-TRANSITORY COMPUTER-READABLE STORAGE MEDIUM

(71) Applicant: CANON KABUSHIKI KAISHA, Tokyo (JP)

(72) Inventors: Norihito Hiasa, Utsunomiya-shi (JP); Koshi Hatakeyama, Tokyo (JP)

(21) Appl. No.: 14/678,113

(22) Filed: Apr. 3, 2015

(30) Foreign Application Priority Data
Apr. 7, 2014 (JP) 2014-078693

(51) Int. Cl. G06T 7/00; H04N 13/02

(52) U.S. Cl. CPC G06T 7/0075; H04N 13/0214; G06T 7/0022; H04N 13/0271; G06T 2207/10012; G06T 2207/10028

(57) ABSTRACT

An image processing apparatus (105) provides reconstruction processing on an input image including parallax images of an object space at different viewpoints and to produce a reconstructed image, and includes a selector (105c) configured to select, from the input image, pixels that have information of an identical region of the object space, a calculator (105d) configured to calculate an average signal value based on signal values of the pixels thus selected, a substitutor (105b) configured to substitute signal values of at least one of the pixels with the average signal value, a producer (105e) configured to produce the reconstructed image from the input image including a pixel whose signal value is substituted with the average signal value, and a determiner (105h) configured to determine whether a first depth of field is smaller than a second depth of field.

### BACKGROUND OF THE INVENTION

1. Field of the Invention

The present invention relates to an image processing apparatus for a plurality of parallax images of an object space at different viewpoints.

2. Description of the Related Art

A recent image pickup apparatus performs calculation and corresponding digital image processing on data obtained by image pickup elements and outputs various images. Ren Ng, et al., “Light Field Photography with a Hand-held Plenoptic Camera”, 2005 Computer Science Technical Report CTSR, discloses an image pickup apparatus that employs “light field photography” to simultaneously acquire the two-dimensional intensity distribution and angle information of light beams from an object space. The two-dimensional intensity distribution and angle information of light beams are collectively called alight field. Acquiring the light field, which corresponds to parallax images, can acquire three-dimensional information of the object space. The parallax images (light field) can be provided with reconstruction processing to perform what is called refocusing, which involves, for example, a focus control, a control of the depth of field, and a change of an image capturing viewpoint after image capturing. Japanese Patent No. 4826152 discloses a method of determining weighting coefficients used to synthesize the parallax images, depending on a focus position to be refocused, and obtaining a refocus image.

Development of a display device has created needs for an image pickup apparatus with a higher image quality. Reduction of noise in an image is important to achieve the higher image quality. Japanese Patent Laid-open No. 6-86332 discloses a method of reducing noise by synthesizing images acquired by a plurality of image pickup systems.

However, the noise is likely to increase by performing the control of the depth of field and the change of an image capturing viewpoint after reconfiguring a plurality of parallax images. This is because only part of the parallax images (a reduced number of parallax images) are used in the reconstruction, or because the parallax images are synthesized with weights having a high ununiformity. A detailed description of this phenomenon is described later.

Japanese Patent No. 4826152 has no description of reduction of noise caused by ununiform weights used to synthesize parallax images. The method disclosed in Japanese Patent Laid-open No. 6-86332 simply synthesizes a plurality of parallax images and perform noise reduction. Thus, the noise increases when the number of parallax images to be synthesized is small or the weights of parallax images are ununiform as described above.

### SUMMARY OF THE INVENTION

The present invention reduces noise in an image obtained by synthesizing a plurality of parallax images.

An image processing apparatus as one aspect of the present invention provides reconstruction processing on an input image including parallax images of an object space at different viewpoints and produces a reconstructed image. The image processing apparatus includes a selector configured to select, from the input image, pixels having information of an identical region of the object space, a calculator configured to calculate an average signal value based on signal values of the pixels thus selected, a substitutor configured to substitute signal values of at least one of the pixels with the average signal value, a producer configured to produce the reconstructed image from the input image including a pixel whose signal value is substituted with the average signal value, and a determiner configured to determine whether a first depth of field of a synthesis image obtained by synthesizing all parallax images included in the input image with uniform weights is smaller than a second depth of field set to produce the reconstructed image. The selector selects the pixels when the first depth of field is smaller than the second depth of field.

Further features and aspects of the present invention will become apparent from the following description of exemplary embodiments with reference to the attached drawings.

### BRIEF DESCRIPTION OF THE DRAWINGS

FIG. 1 is a block diagram of an image pickup apparatus according to Embodiments 1 and 3 of the present invention.

FIG. 2 is a schematic configuration diagram of an image pickup optical system according to Embodiment 1.

FIG. 3 is a schematic configuration diagram of an image pickup optical system according to Embodiment 2.

FIG. 4 is a schematic configuration diagram of an image pickup optical system according to a variation of Embodiment 2.

FIG. 5 is a schematic configuration diagram of an image pickup optical system according to Embodiment 3.

FIG. 6 is a detailed cross-sectional view of an image pickup optical system according to Embodiment 1.

FIGS. 7A to 7D are explanatory diagrams of exemplary produced parallax images and synthesis thereof.

FIG. 8 illustrates a relation between an image pickup element and a lens array according to Embodiment 1.

FIGS. 9A to 9D each illustrate a relation between weights used in an image synthesis and a reproduced pupil according to Embodiment 1.

FIG. 10 illustrates a relation between an image pickup region and an object space according to Embodiment 1.

FIG. 11 illustrates an image plane on which two pixels acquire information of an identical region according to Embodiments 1 and 2.

FIG. 12 is an explanatory diagram of a processing flow according to Embodiments 1 to 3.

FIG. 13 is a block diagram of an image processing system according to Embodiment 2.

FIG. 14 is an exterior diagram of the image processing system according to Embodiment 2.

FIG. 15 is a detailed cross-sectional view of the image pickup optical system according to Embodiment 2.

FIG. 16 is a schematic configuration diagram of the image pickup optical system according to Embodiment 3.

FIG. 17 is a detailed cross-sectional view of part of the image pickup optical system according to Embodiment 3.

FIG. 18 illustrates an object plane on which two pixels acquire information of an identical region according to Embodiment 3.

### DESCRIPTION OF THE EMBODIMENTS

Exemplary embodiments of the present invention will be described below with reference to the accompanied drawings. In each of the drawings, the same elements will be denoted by the same reference numerals and the duplicate descriptions thereof will be omitted.

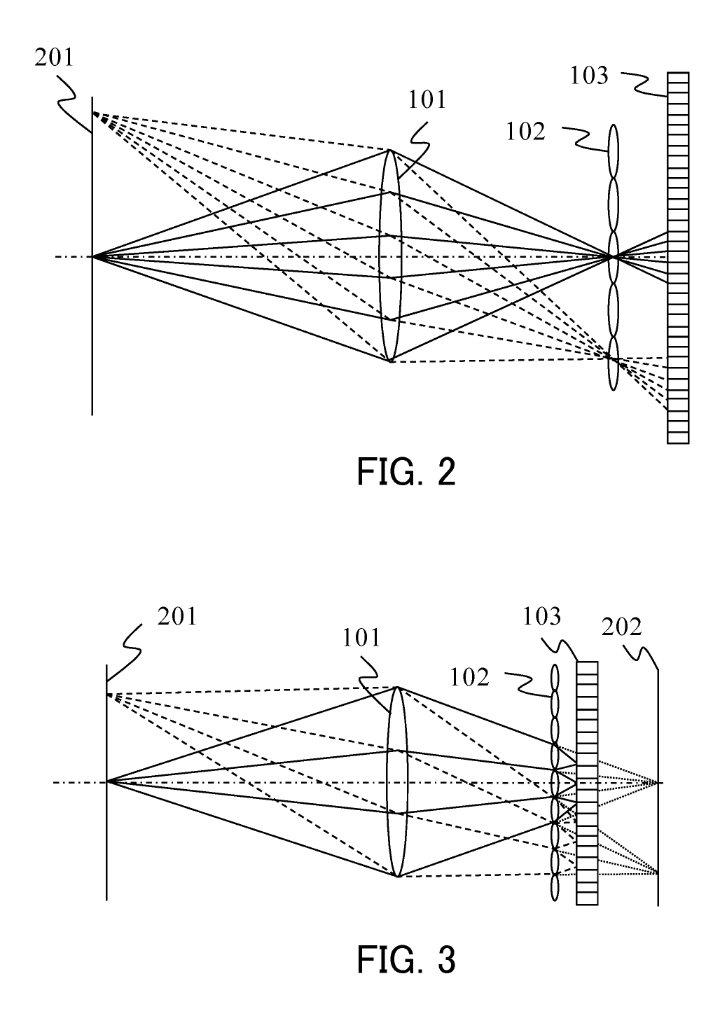

An input image to be provided with image processing according to each embodiment of the present invention includes parallax images of an object space at different viewpoints. The input image is acquired by an image pickup apparatus having, for example, a configuration illustrated in FIGS. 2 to 4 in which a lens array is disposed on an image side of an imaging optical system, or a configuration illustrated in FIG. 5 in which a plurality of imaging optical systems are arranged. Alternatively, the parallax images can be acquired by a method of capturing images a plurality of times while changing the position of the image pickup apparatus including the imaging optical system and an image pickup element. However, this method obtains the parallax images of the object space at times different from each other. Thus, when an object in the object space is moving, the method fails to obtain correct parallax information. Therefore, the image pickup apparatus for acquiring the parallax images desirably has the configurations illustrated in FIGS. 2 to 5 that are capable of simultaneously acquiring a plurality of parallax images.

There does not necessarily need to exist a person or an object on an object plane in FIGS. 2 to 5. This is because a focus position can be adjusted to any person or object farther or nearer than the object plane by refocusing after image capturing.

Descriptions of the embodiments below may be made on a one-dimensional system for simplicity, but the same argument holds true for a two-dimensional system.

### Embodiment 1

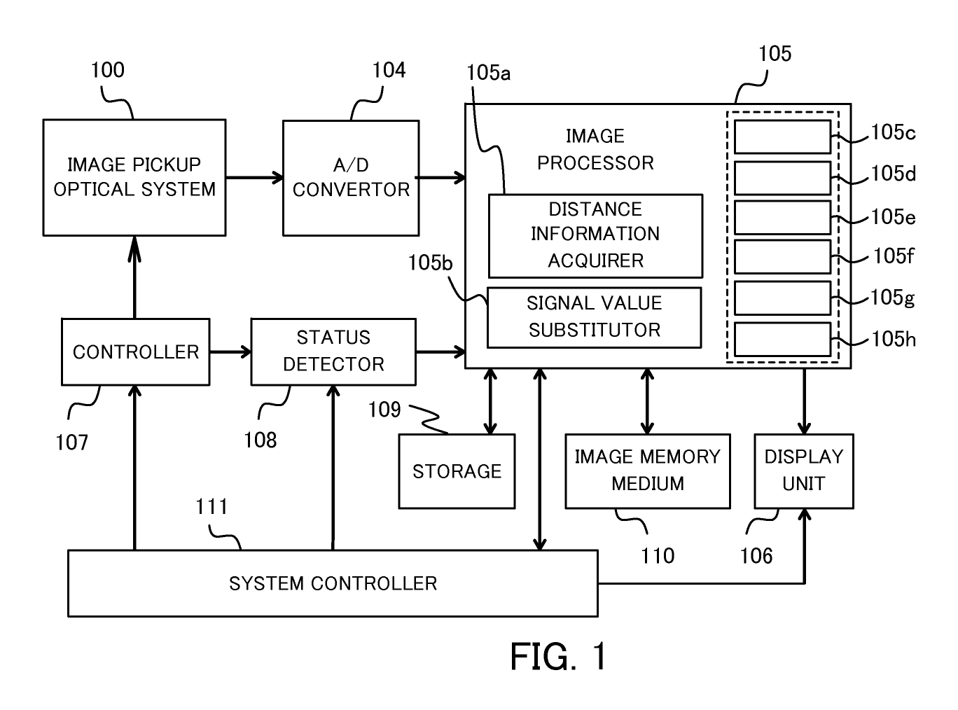

Next follows a description of Embodiment 1 of an image pickup apparatus that employs an image processing method of the present invention. The description will explain a basic configuration of the image pickup apparatus with reference to FIGS. 1 and 2.

A light beam from an object space (not illustrated) enters into an image pickup optical system 100 in FIG. 1. As illustrated in FIG. 2, the image pickup optical system 100 includes, from an object side, an imaging optical system 101, a lens array 102, and an image pickup element 103 including an array of a plurality of pixels. The image pickup optical system 100 serving as an image pickup unit can produce the input image including parallax images of the object space at different viewpoints. The image pickup element 103 is a two-dimensional image pickup element such as a charge coupled device (CCD) and a complementary metal-oxide semiconductor (CMOS). The image pickup element 103 converts energy of the light beam having passed through the imaging optical system 101 and the lens array 102 into an analog electric signal. The analog signal is then converted into a digital signal by an A/D convertor 104. The digital signal is provided with predetermined processing by an image processor 105, and is stored in an image memory medium 110 such as a semiconductor memory in a predetermined format. The image memory medium 110 also stores image capturing condition information of the image pickup apparatus obtained by a status detector 108. The image capturing condition information includes the configuration of the image pickup optical system 100, an image capturing distance, an aperture value, and a focal length of a zoom lens. The status detector 108 may obtain the image capturing condition information from a system controller 111, and may obtain information of the image pickup optical system 100 from a controller 107.

Displaying an image stored in the image memory medium 110 on a display unit 106 involves a noise reduction and reconstruction processing to produce a display image (reconstructed image), which are characteristics of this embodiment, at the image processor 105. Thus, the image processor 105 in this embodiment serves as, for example, an image processing apparatus that provides the reconstruction processing to the input image obtained from the image memory medium 110 and produces the reconstructed image. The image processor 105 includes a selector 105c that selects, from the input image, pixels for the noise reduction, and a calculator 105d that calculates an average signal value based on a signal value of each pixel in the selected pixels. The image processor 105 also includes a signal value substitutor 105b that substitutes signal values of at least one of the pixels with the average signal value. The image processor 105 also includes a producer 105e that produces the reconstructed image from the input image including a pixel whose signal is substituted with the average signal value. The image processor 105 also includes an image capturing condition information acquirer 105f that acquires the image capturing condition information at the time of capturing the input image stored in the image memory medium 110, and a distance information acquirer 105a that acquires distance information of the object space. The selector 105c selects pixels for the noise reduction from the input image based on the image capturing condition information acquired by the image capturing condition information acquirer 105f and the distance information of the object space acquired by the distance information acquirer 105a. The calculator 105d calculates the average signal value based on a signal value of each of the pixels thus selected, and the signal value substitutor 105b substitutes signal values of at least one of the pixels with the average signal value, and reduces noise. These processes will be described in detail later. The image whose noise is thus reduced is reconstructed by the producer 105e with desired settings such as the viewpoint, the focus position, the depth of field of the image, and the reconstructed image thus reconstructed is displayed on the display unit 106. For faster processing, the desired settings may be previously stored in a storage 109, and the reconstructed image may be directly displayed on the display unit 106 without being stored in the image memory medium 110. Similarly, for faster processing, the noise reduction may be provided when an image is recorded in the image memory medium 110 after image capturing. Alternatively, the image memory medium 110 may record the image after the reconstruction.

The system controller 111 provides this series of controls, and instructs the controller 107 to mechanically drive the image pickup optical system 100.

Next follows a description of the configuration of the image pickup optical system 100 according to Embodiment 1. FIG. 2 illustrates a schematic configuration diagram of the image pickup optical system 100. The lens array 102 is disposed on an image side conjugate plane of an object plane 201 with respect to the imaging optical system 101. The lens array 102 is arranged such that an exit pupil of the imaging optical system 101 and the image pickup element 103 substantially have a conjugate relation. Light beams from the object plane 201 passing through the imaging optical system 101 and the lens array 102 enter into pixels of the image pickup element 103 that are different from each other, depending on the positions and angles of the light beams on the object plane 201. In this manner, parallax images (light field) are acquired. The lens array 102 prevents light beams passing through different positions on the object plane 201 from entering into an identical pixel. Consequently, the image pickup element 103 acquires an image including arrays of pixels resulted from image capturing of an identical region on the object plane 201 at a plurality of viewpoints.

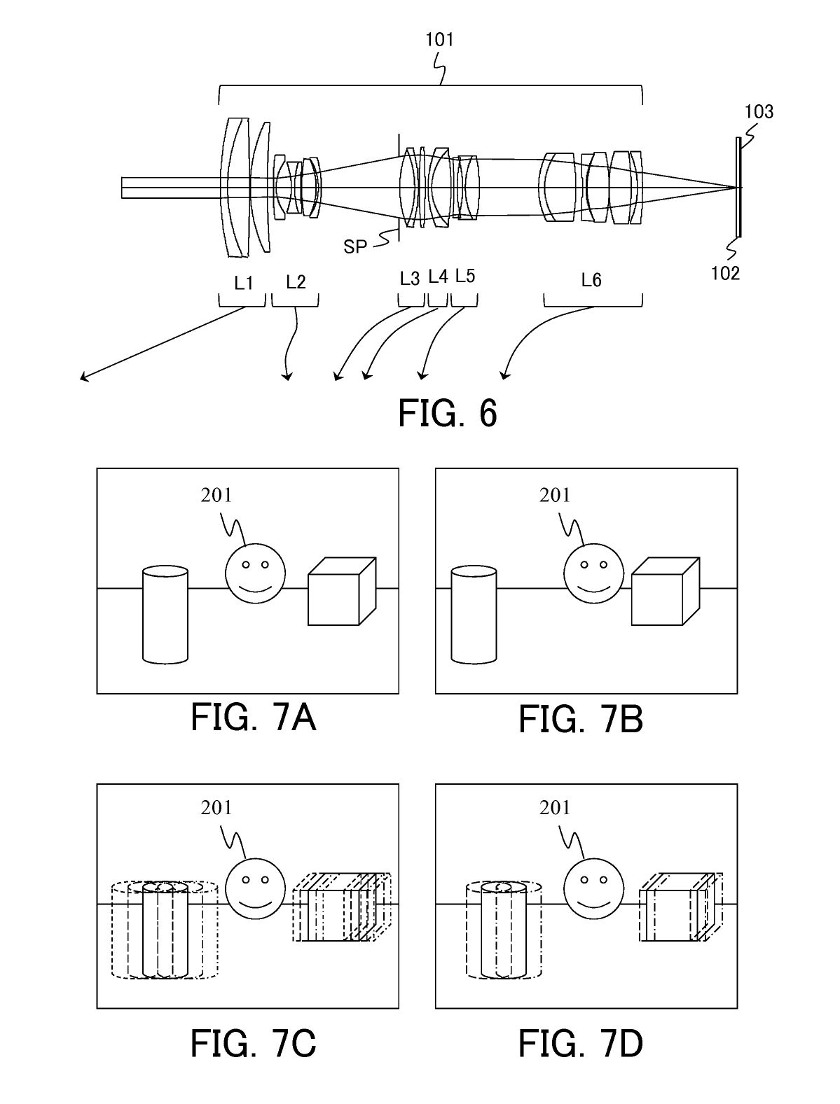

FIG. 6 is a detailed cross-sectional view of the image pickup optical system 100 according to this embodiment. The imaging optical system 101 in FIG. 6 is a zoom lens. The imaging optical system 101 includes a first lens unit L1 having a positive refractive power, a second lens unit L2 having a negative refractive power, a third lens unit L3 having a positive refractive power, a fourth lens unit L4 having a positive refractive power, a fifth lens unit L5 having a negative refractive power, and a sixth lens unit L6 having a positive refractive power. SP denotes an aperture stop. The imaging optical system 101 becomes in focus by driving the second lens unit L2 in an optical axis direction while intervals between the lens units are changed during a magnification variation. The lens array 102 includes a single solid lens in this embodiment, but may include a plurality of lenses and may include a liquid lens, a liquid crystal lens, and a diffractive optical element. Although a small lens included in the lens array 102 in Embodiment 1 has convex surfaces, it is desirable in terms of aberration that the surface of the small lens on the image side has a convex shape, and the surface on the object side has a plane or convex shape. The convex shape of the surface on the image side reduces astigmatism and provides a high quality image. Strong aberration would degrade the sharpness of a reconstructed image. The aberration can be reduced also by the plane or convex shape of the surface on the object side, improving the sharpness of the image.

Next follows a description of the reconstruction processing involving refocusing, a control of the depth of field, and a change of an image capturing viewpoint. Since the reconstruction processing is disclosed in Non Patent Document 1, a brief description thereof will be given below.

First, the refocusing will be described. The basic principle of the refocusing is the same in configurations in FIGS. 2 to 5. The description is thus made on the configuration in FIG. 2 as an example. In FIG. 2, the pupil of the imaging optical system is two-dimensionally divided into 25 pupil regions (five pupil regions for each dimension), and images are captured at 25 viewpoints. Hereinafter, an image corresponding to a divided pupil region is referred to as a single-viewpoint image. Single-viewpoint images captured at 25 viewpoints have parallax between one another, which is reflected on different relative positional relations among objects on the images depending on object distances. FIGS. 7A and 7B are exemplary single-viewpoint images. Since the object distance increases in order of a cylinder, a cube, and a human face in FIGS. 7A to 7D, the positions of these objects relative to one another differ between the single-viewpoint images due to the parallax. When the single-viewpoint images are synthesized such that a certain object therein overlaps with itself in the images, the other objects positioned at different object distances are shifted from themselves in a synthesis image. This shift results in blurred images of the objects positioned at different object distances. FIG. 7C illustrates an exemplary image obtained by synthesizing the parallax images such that the human face overlaps with itself. For simplification of FIG. 7C, single-viewpoint images are represented by a solid line, a broken line, and a dashed line, and the parallax images are synthesized only in one dimension. The blur in the synthesis image depends on a pupil corresponding to the single-viewpoint images used in the synthesis, and synthesizing all images at 25 viewpoints can reproduce blur included in an image captured by the imaging optical system 101. Since the object to be overlapped in the synthesis of the single-viewpoint images is arbitrary, an image captured by the imaging optical system 101 focusing on an arbitrary object can be reproduced. This is a focus control after image capturing, that is, the principle of the refocusing.

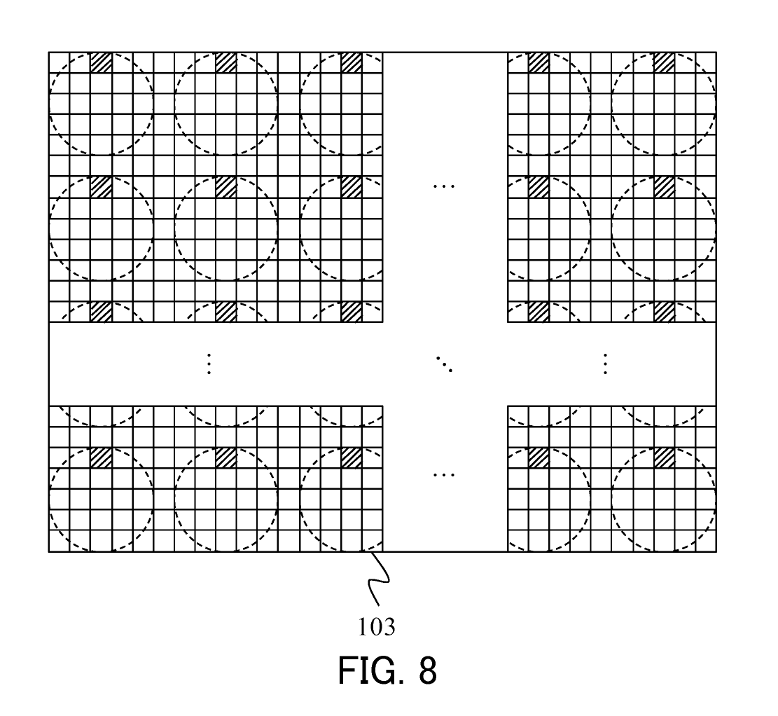

Next follows a description of a method of producing the single-viewpoint images according to Embodiment 1. FIG. 8 illustrates a relation between the lens array 102 and the image pickup element 103 in FIG. 2. A dashed circle represents a pixel region into which a light beam having passed through one small lens enters, and corresponds to the pupil of the imaging optical system 101. In FIG. 8, the influence of vignetting, which is present at a high image height in a real lens, is neglected for simplification. Although FIG. 8 corresponds to a configuration in which small lenses are arranged in a lattice structure, the arrangement of the small lenses is not limited thereto. For example, the small lenses may be arranged with a six-fold symmetry, or may be shifted off a regular arrangement by small amounts. A hatched area in FIG. 8 represents a pixel into which light beams having passed through the same pupil region of the imaging optical system 101 enter. Thus, selecting hatched pixels can produce a single-viewpoint image of the object space viewed at a bottom part of the pupil of the imaging optical system 101. Similarly, selecting pixels whose relative positions on dashed circles are the same can produce other single-viewpoint images.

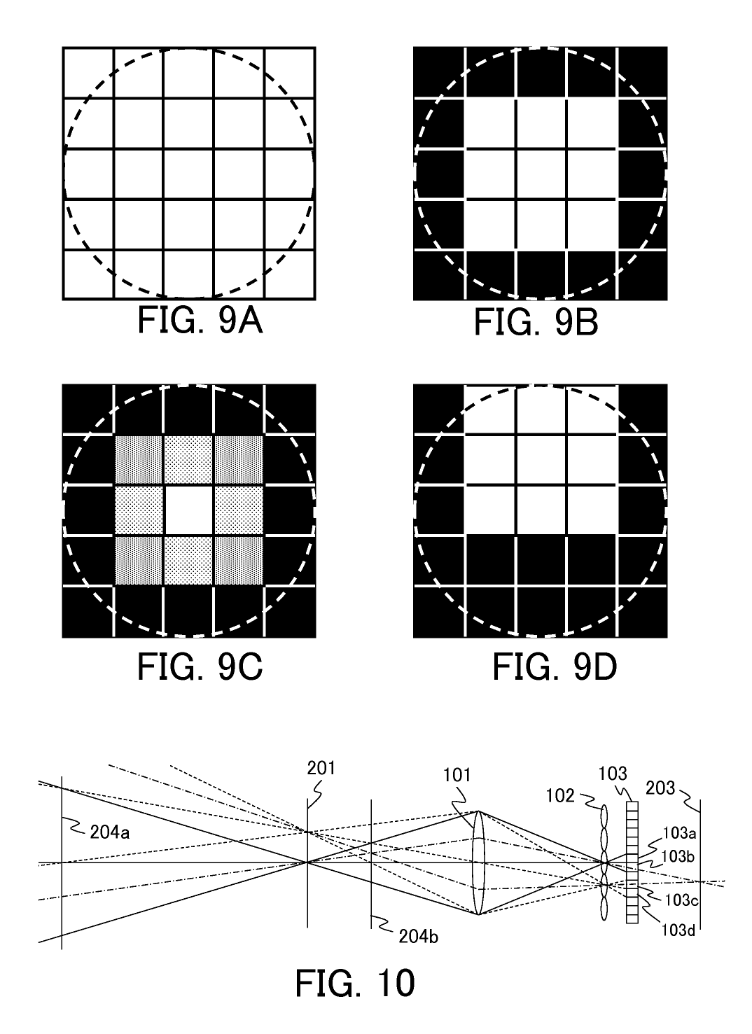

Next follows a description of the control of the depth of field and the change of the image capturing viewpoint after image capturing. Each single-viewpoint image is an image of a divided region of the pupil of the imaging optical system 101. Therefore, synthesizing all parallax images reproduces the entire pupil of the imaging optical system 101, and synthesizing only part of the parallax images can reproduce part of the pupil of the imaging optical system 101, that is, a narrowed aperture stop. FIGS. 9A to 9D are each an enlarged view of a pixel region corresponding to one small lens in FIG. 8. A dashed circle corresponds to the pupil of the imaging optical system 101, and each divided pupil region corresponds to a pixel. Images of the divided pupil regions are multiplied with weights and synthesized with one another. FIGS. 9A to 9D illustrate the weights in grayscale. Black represents zero weight, and a brighter color represents a larger weight. Synthesizing images of all pupil regions with equal weights as illustrated in FIG. 9A reproduces the pupil of the imaging optical system 101 represented by the dashed circle. Setting weights for a peripheral part of the pupil to be zero as illustrated in FIG. 9B reproduces part of the pupil, that is, the imaging optical system 101 with the aperture stop being narrowed. FIG. 7C illustrates an exemplary image reconstructed under the arrangement of FIG. 9A, and FIG. 7D illustrates an exemplary image reconstructed under the arrangement of FIG. 9B. However, for simplification, the parallax images are synthesized only in one dimension in FIGS. 7A to 7D. The configuration of FIG. 9B represents a smaller pupil than that of FIG. 9A and thus leads to a larger f-number, so that a reconstructed image has an increased depth of field as illustrated in FIG. 7D. The weight of each pupil region is limited to two values in FIG. 9B, but may take a plurality (three or more) of values depending on the pupil regions as illustrated in FIG. 9C. Furthermore, the weights for the peripheral part of the pupil do not necessarily need to be zero, and may have significantly smaller values than those for a central region. However, for faster reconstruction processing, a smaller number of images to be synthesized is desirable. Therefore, an image that reproduces part of the pupil of the imaging optical system 101 is desirably produced by setting weights of other regions except for corresponding pupil regions to be zero and thus using part of the parallax images.

As described above, the depth of field can be controlled by changing the weight of each pupil region in the synthesis of the parallax images. This control is also applicable to the change of the image capturing viewpoint. The image capturing viewpoint of a reconstructed image can be changed by shifting the center of the region of a pupil to be synthesized off the center of the pupil as illustrated in FIG. 9D.

Next follows a description of the noise reduction as the characteristic of this embodiment. Noise is assumed to be dominated by shot noise. For simplification, the image pickup element 103 is assumed to have a linear gain. The conventional problem will be described first. For example, the images illustrated in FIGS. 7A to 7D are acquired with the configuration of FIG. 2. Completely reproducing the pupil of the imaging optical system 101 requires all parallax images from the 25 viewpoints to be synthesized with substantially uniform weights. Synthesizing M (>1) pixels reduces the noise M^{-0.5} times through averaging. This is because the shot noise obeys a Poisson distribution and thus M times increase of the number of detected photons increases the S/N ratio M^{0.5} times. Thus, synthesizing the parallax images from the 25 viewpoints reduces the noise of a reconstructed image 1/5 times. However, in the control of the depth of field and the change of the image capturing viewpoint, the single-viewpoint images are weighted as illustrated in FIG. 9B or 9D, and thus the number of parallax images to be synthesized is reduced. With the configuration of FIG. 9B, the synthesis is performed with the parallax images from nine viewpoints, and thus the effect of the noise reduction decreases 1/3 times. Although the weights for the peripheral part of the pupil are set to zero in FIG. 9B, setting significantly small finite weights can produce an image having the depth of field substantially equal to that obtained with the zero weights. Since weights used in the synthesis of the pupil regions are extremely ununiform, however, the effect of the noise reduction through averaging is still low at 1/3 times approximately.

The description so far is summarized as follows. Increase of the depth of field and movement of the viewpoint off the center of the pupil of the imaging optical system 101 increase the nonuniformity of the weights used in the synthesis of the pupil regions. The increase of the nonuniformity reduces the effect of the noise reduction through averaging. Thus, the effect of the noise reduction is weakened in the control of the depth of field and the change of the image capturing viewpoint.

Next follows a description of the the noise reduction, which is a characteristic of this embodiment. The surface of an object in the object space is assumed to be uniformly diffusive. In the configuration in FIG. 2, the object plane 201 has no parallax among all single-viewpoint images. In other words, the pixels capturing an image of the object in the object plane 201 capture images of an identical region at any viewpoints, and thus have the same signal value except for noise. Thus, the average signal value of these pixels is calculated to substitute the original signal values. This provides the pixels whose signal values are substituted, with the noise reduction equivalent to that obtained in synthesis of all parallax images, independently from the number of synthesized images and weights in the reconstruction.

This processing is described by using expressions below. A signal value of a pixel at the j-th viewpoint among pixels that have information of an identical region is represented by Sⱼ. Sⱼ is expressed as Sⱼ=sⱼ+nⱼ with a noise component nⱼ and an original signal value sⱼ. When the number of viewpoints in the pixels is M, an average signal value Sₘ of a pixel at each viewpoint is written as Expression (1) below:

$${S}_{m} = {\sum }_{j}^{M} {w}_{j} {S}_{j} = {\sum }_{j}^{M} {w}_{j} ( {s}_{j} + {n}_{j} ) \qquad ( 1 )$$

where wⱼ is a coefficient representing a weight, which satisfies Expression (2) below.

$${\sum }_{j}^{M} {w}_{j} = 1 \qquad ( 2 )$$

When the signal values sⱼ except for the noise component nⱼ can be written as s, Expression (1) is rewritten as Expression (3) below.

$${S}_{m} = s + {\sum }_{j}^{M} {w}_{j} {n}_{j} \qquad ( 3 )$$

The average signal value Sₘ is substituted into each signal value sⱼ of the pixels. Sₘ is a signal whose noise is reduced as compared to that of Sᵢ through averaging. For example, when the weight wⱼ is 1/M for all j, the S/N ratio of Sₘ is M^{0.5} times that of Sⱼ. The average signal value may be a value obtained by averaging each signal value with an equal weight, or a value calculated with different weights. A method of calculating the average signal value with different weights may involve first calculating the average signal value with an equal weight and then allocating a larger weight for a pixel whose value is closest to the average signal value among signal values before substitution.

The weight of each pixel is desirably determined depending on the light quantity of light entering into the pixel. There occur differences in the light quantity among the single-viewpoint images, for example, because the pupil of the imaging optical system 101 is not divided into equal areas as illustrated in FIG. 9A, or due to influence of vignetting of the imaging optical system 101. Since a pixel receiving a smaller light quantity is more largely affected by noise, the pixel is desirably allocated with a reduced weight.

In the control of the depth of field and the change of the image capturing viewpoint, as described above, the reduced number of synthesized parallax images or the nonuniformity of weights used in the synthesis results in a degraded effect of the noise reduction. However, performing the reconstruction after the substitution can yield a high effect of the noise reduction at part of an image (part that captures an image of the object plane 201).

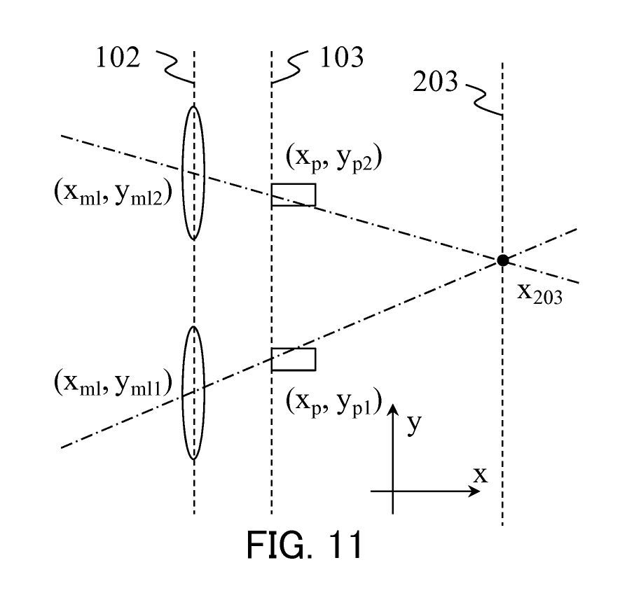

In the description so far, for simplification, pixels whose signal values are substituted with the average signal value are restricted to pixels capturing images of the object plane 201. However, this embodiment is applicable to any pixels that have information of an identical region of the object space, in addition to the pixels capturing images of the object plane 201. FIG. 10 illustrates pixels 103a to 103d being projected into the object space through the lens array 102 and the imaging optical system 101. In FIG. 10, the pixels 103a and 103d have information of an identical region at an object distance 204a. Similarly, the pixel 103b and the pixel 103c have information of an identical region at the object distance 204b. When the image pickup element 103 has information of an object at such an object distance, pixels corresponding to the object have substantially the same signal values except for noise. Thus, calculating and substituting the average signal value yields the effect of the noise reduction as described above. The object distances at which two pixels at two viewpoints have information of an identical region can be calculated based on a relation illustrated in FIG. 11. In FIG. 11 illustrating two arbitrary different pixels, an ellipse represents an arbitrary small lens of the lens array 102, a rectangle represents an arbitrary pixel corresponding to the arbitrary small lens, and a dashed line represents a light beam passing through the principal point of the small lens and the center of the pixel. In FIG. 11, (xₘₗ, yₘₗᵢ) represents the coordinates of the principal point of the small lens, and (xₚ₁, yₚᵢ) represents the central coordinates of the pixel. Since the two pixels are different from each other, the relation yₚ₂ yₚ₂ holds for i=1, 2 while the relation yₘₗ₁=yₘₗ₂ may hold. Since no two or more pixels have information of an identical region at an identical viewpoint, the relation yₘₗ₁=yₘₗ₂−yₚ₂ holds. The coordinate x₂₀₃ of a plane 203 at which two light beams intersect with each other is written as Expression (4) below.

$${x}_{203} = \frac{{x}_{p} ( {y}_{ml 1} - {y}_{ml 2} ) - {x}_{ml} ( {y}_{p 1} - {y}_{p 2} )}{( {y}_{ml 1} - {y}_{m l 2} ) - ( {y}_{p 1} - {y}_{p 2} )} \qquad ( 4 )$$

The conjugate plane of the plane 203 with respect to the imaging optical system 101 is at an object distance at which the two pixels have information of the identical region. The relation between the planes is illustrated with the plane 203 and the object distance 204b in FIG. 10. For simplification, a two-dimensional coordinate system is assumed, and the principal plane interval of the small lens is ignored. In a real system, Expression (4) may be generalized to a three-dimensional coordinate system. The principal plane interval is desirably taken into account in calculation of an object distance conjugate with the distance of the plane 203. The correspondence of each pixel to an object at an object distance can be determined by obtaining distance information of the object space. The distance information may be calculated from parallax images, or may be acquired by using, for example, an infrared range finder.

It is to be noted that although there exist pixels capturing images of an identical region at the object plane 201 in the configuration of FIG. 2, there are not necessarily such pixels in the configurations of FIGS. 3 to 5. However, the configurations of FIGS. 3 to 5 allow pixels having information of an identical region and the object distances thereof to be determined similarly by projecting the pixels onto the object space.

In addition, pixels whose signal values are substituted with the average signal value do not necessarily need to capture images of a completely identical region. A light intensity distribution of the object space is distributed continuously except at an edge of the object. Thus, as long as regions corresponding to the pixels are substantially identical to one another except for the edge, their signal values can be assumed to be substantially identical except for noise. For example, when the areas of two pixels projected on the object space overlap with each other more than half, the two pixels can be assumed to have information of substantially identical regions. In the present invention, selection of a such pixels having information of substantially identical regions is referred to as selection of pixels having information of an identical region of the object space. Thus, when the two pixels do not capture images of the edge of the object, the average signal value may be calculated and signal values may be substituted.

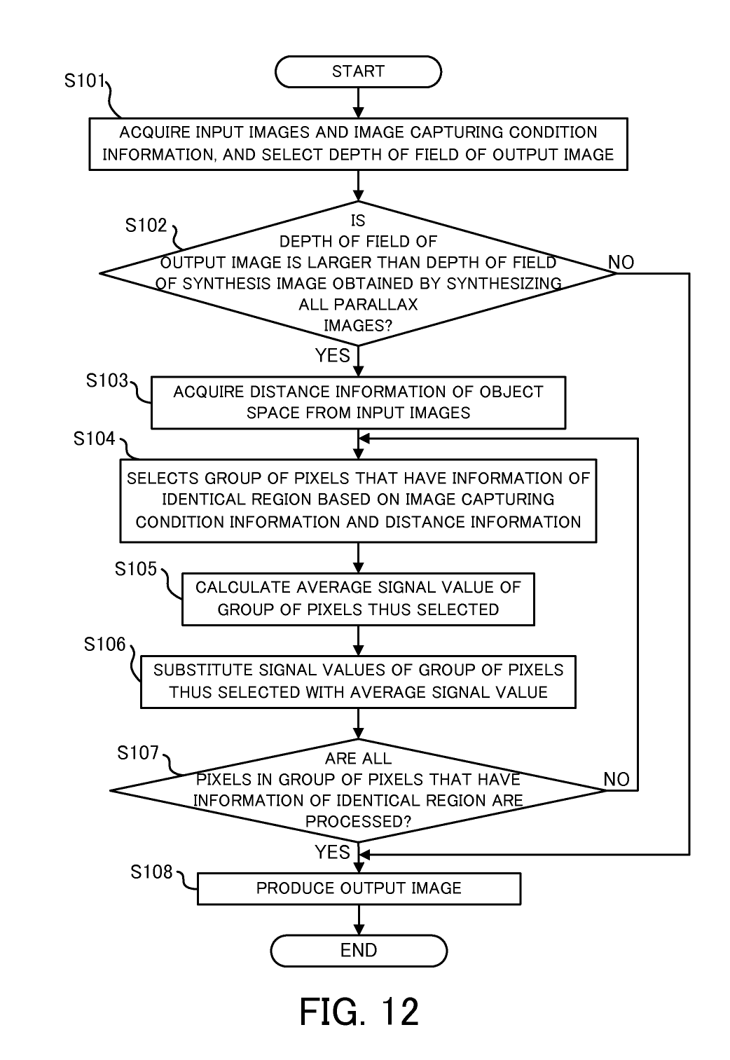

Next follows a description of an image processing flow of producing an output image (reconstructed image) from the input image in Embodiment 1 with reference to a flowchart illustrated in FIG. 12. Step S101 corresponds to an image capturing condition information acquiring process and an output image selecting process, step S103 corresponds to a distance information acquiring process, steps S104 to S106 correspond to a substituting process, and step S108 corresponds to an output image producing process. The image processor 105 performs operations in the flowchart illustrated in FIG. 12.

At step S101, the image processor 105 acquires the input image, the image capturing condition information acquirer 105f acquires the image capturing condition information, and the depth of field of the output image is selected. The input image is captured by the image pickup optical system 100 illustrated in FIG. 6, and the image capturing condition information includes the configuration and optical parameters of the image pickup optical system 100 when the input image is captured. The input image may be captured by a similar image pickup optical system and stored in the image memory medium 110. The depth of field of the output image may be selected automatically or by a user. Instead of being directly selected, the depth of field may be determined by selecting, for example, the f-number. For this purpose, the image processor 105 includes a selector 105g (setter) that selects (sets) the depth of field of the output image (second depth of field).

At step S102, depending on the depth of field of the output image that is selected, the following processing is bifurcated. As described above, the present invention is effective when weights used to synthesize pupil regions have a high nonuniformity. The depth of field of the output image, which is large when weights are set ununiform to perform the control of the depth of field and the change of the image capturing viewpoint, can be used to determine the bifurcation. The depth of field of the output image is compared to the depth of field of a synthesis image obtained by synthesizing all parallax images included in the input image with substantially uniform weights. When the depth of field of the synthesis image is smaller than that of the output image, the image processing method of the present invention is applied. Otherwise, the flow proceeds to step S107. For this purpose, the image processor 105 includes a determiner 105h that determines whether a first depth of field of the synthesis image obtained by synthesizing all parallax images included in the input image is smaller than the second depth of field set to produce the output image.

At step S103, the distance information of the object space is acquired by the distance information acquirer 105a. In this embodiment, the distance information is calculated based on parallax information included in the input image. However, the distance information may be acquired by any other method.

At step S104, the selector 105c selects, from the input image, pixels that have information of an identical region of the object space. An object distance at which a plurality of pixels have information of an identical region is obtained based on an object distance at which the parallax is zero or by a method using Expression (4), and the pixels are selected based on the distance information acquired at the previous step. Another possible method produces single-viewpoint images and calculates corresponding points in each image by, for example, a block matching method. When differences between signal values of corresponding pixels are smaller than or equal to a predetermined threshold, it is determined that the pixels have information of an identical region, and the pixel are selected.

At step S105, the calculator 105d calculates the average signal value of the pixels thus selected. The average signal value may be calculated with an equal weight or with appropriate weights. As described above, a weight is desirably determined depending on the light quantity of light that enters into each pixel.

At step S106, the signal value substitutor 105b substitutes signal values of the pixels thus selected with the average signal value thus calculated. Signal values of the all pixels may be substituted, or only those of pixels used to produce the output image may be substituted.

At step S107, the flow is bifurcated depending on whether all the pixels that have information of an identical region are processed. When there is any of the pixels yet to be processed, the flow proceeds to step S104. When all pixels are processed, the flow proceeds to step S108. However, not all the pixels necessarily need to be processed before the output image is produced. For example, the substituting process is performed only on pixels that capture images of an object at the object plane 201 but not on pixels corresponding to other object distances.

At step S108, the producer 105e produces the output image (reconstructed image) from the input image including the pixels whose signals are substituted.

Other noise reduction processes may be performed as necessary. Such processes include coring processing that removes any minute difference between signal values of adjacent pixels as noise, and processes with a bilateral filter and a median filter. These noise reduction processes may be performed on an image of each viewpoint or on the output image after synthesis.

Moreover, the refocusing processing may be performed simultaneously with the control of the depth of field and the change of the image capturing viewpoint.

The configuration described above can provide the image pickup apparatus that employs the image processing method of reducing noise in an image that is obtained by synthesizing parallax images and provided with the control of the depth of field and the change of the image capturing viewpoint.

### Embodiment 2

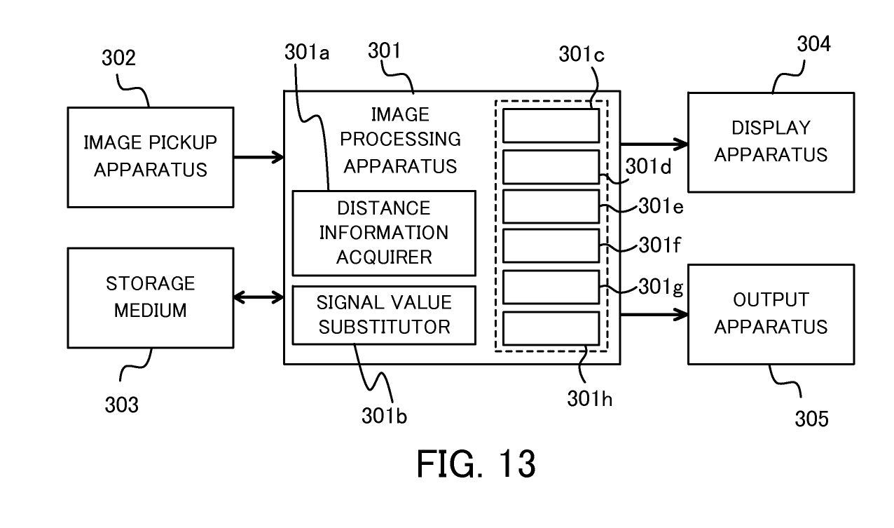

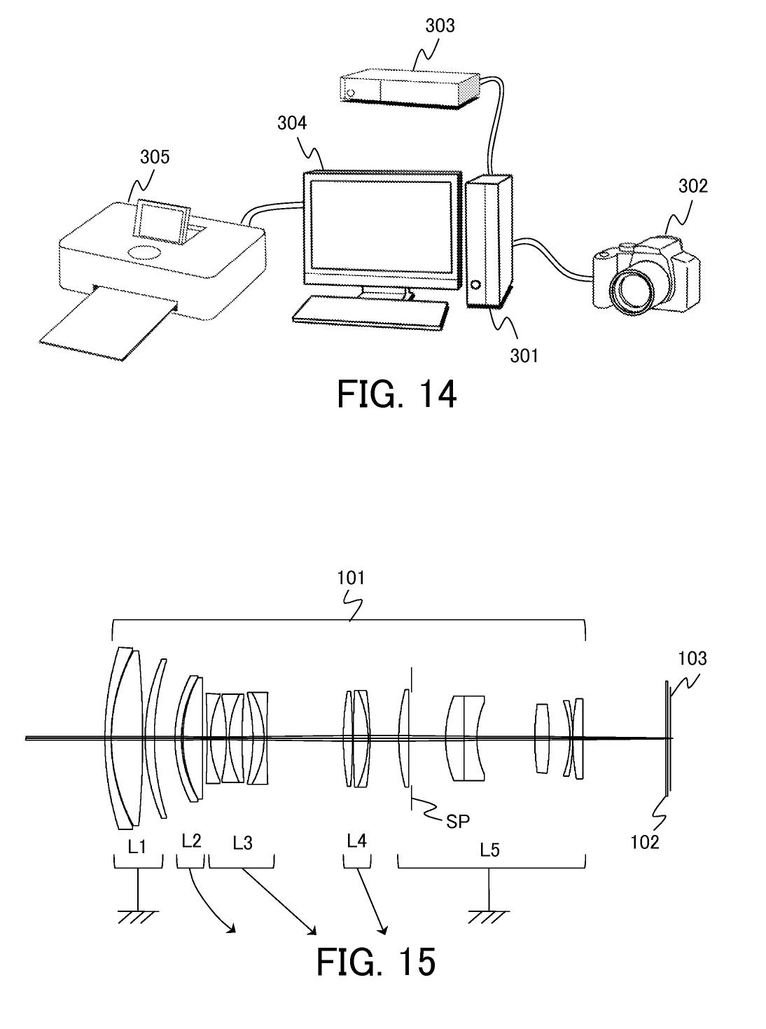

Next follows a description of Embodiment 2 of an image processing apparatus that employs the image processing method of the present invention. FIG. 13 illustrates a basic configuration of the image processing system that employs the image processing method of the present invention, and FIG. 14 illustrates an exterior diagram of the image processing system. As illustrated in FIGS. 13 and 14, the image processing system includes an image pickup apparatus 302. The image pickup apparatus 302 includes an image pickup optical system having the configuration illustrated in FIG. 3. An image processing apparatus 301 is a computer device that performs the image processing method of the present invention. An image acquired by the image pickup apparatus 302 is provided with the noise reduction and predetermined reconstruction processing by the image processing apparatus 301, and is output to one or more of a non-transitory computer-readable storage medium 303, a display apparatus 304, and an output apparatus 305. The non-transitory computer-readable storage medium 303 is, for example, a semiconductor memory, a hard disk, and a server on a network. The display apparatus 304 is, for example, a liquid crystal display and a projector. The output apparatus 305 is, for example, a printer. The display apparatus 304 is connected with the image processing apparatus 301 and receives a reconstructed image. A user can see the reconstructed image on the display apparatus 304 while working. The image processing apparatus 301 has a function to perform development processing and other image processing as necessary in addition to the noise reduction and the reconstruction processing. In the image processing apparatus 301, an selector 301c selects pixels capturing images of an identical region based on distance information of the object space that is acquired by a distance information acquirer 301a and the image capturing condition information of the image pickup apparatus 302 that is acquired by an image capturing condition information acquirer 301f. A calculator 301d calculates the average signal value based on signal values of the pixels thus selected, and a signal value substitutor 301b substitutes the signal values of the pixels with the average signal value so as to perform the noise reduction. The image provided with the noise reduction is reconstructed with desired settings by a producer 301e and a reconstructed image is produced. The image processing apparatus 301 includes a selector 301g and a determiner 301h that correspond to the selector 105g and the determiner 105h described in Embodiment 1, respectively. A detailed description of these components will be omitted as given in Embodiment 1.

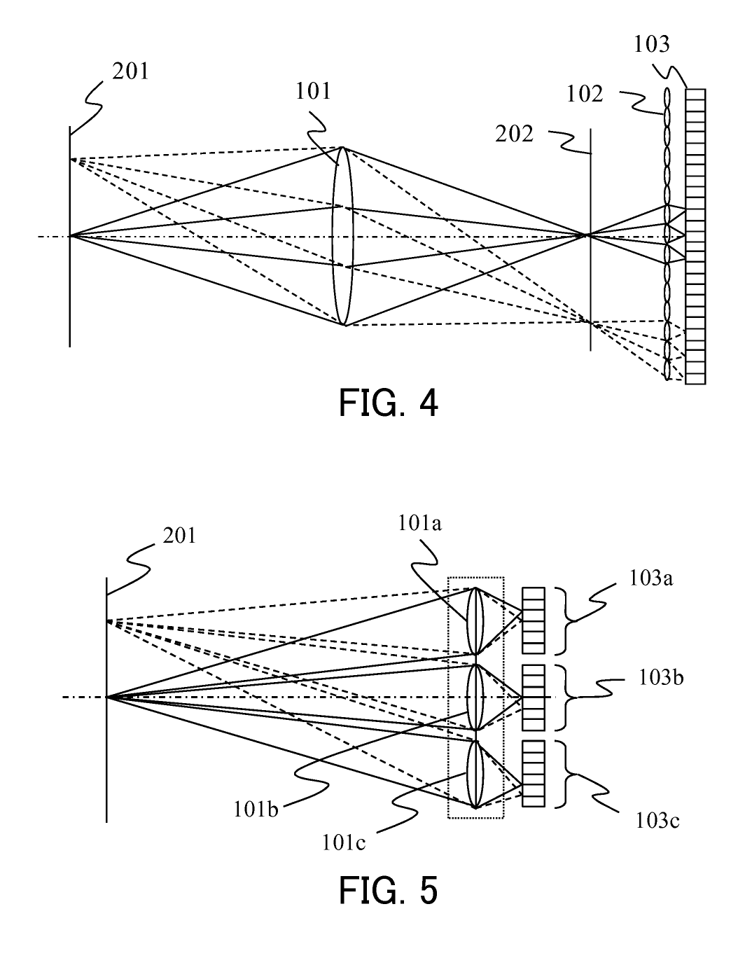

The image pickup optical system included in the image pickup apparatus 302 according to Embodiment 2 has the arrangement illustrated in FIG. 3, and FIG. 15 illustrates a detailed cross-sectional view thereof. The imaging optical system 101 includes a first lens unit L1 having a positive refractive power, a second lens unit L2 having a positive refractive power, a third lens unit L3 having a negative refractive power, a fourth lens unit L4 having a positive refractive power, and a fifth lens unit L5 having a positive refractive power. SP denotes an aperture stop. In magnification, the first lens unit L1 and the fifth lens unit L5 are fixed, and the second lens unit L2, the third lens unit L3, and the fourth lens unit L4 are moved on an optical axis. Focusing is performed through the second lens unit L2. In FIG. 3, the lens array 102 is disposed closer to the object side than an image side conjugate plane 202 of the object plane 201 with respect to the imaging optical system 101, and the image side conjugate plane 202 and the image pickup element 103 are disposed to have a conjugate relation with respect to the lens array 102. Light beams from the object plane 201 passing through the imaging optical system 101 and the lens array 102 enters into pixels of the image pickup element 103 that are different from each other, depending on the position and angle of the light beams on the object plane 201. In this manner, parallax images (light field) are acquired. With the configurations in FIGS. 3 and 4, the image pickup element 103 acquires an image having an array of a plurality of small images of the image capturing viewpoints and image capturing ranges that are different from one another. The configuration in FIG. 4 is the same as that illustrated in FIG. 3 except that the lens array 102 is disposed closer to the image side than the image side conjugate plane 202. The configuration in FIG. 4 differs from that in FIG. 3 in that the lens array 102 treats an image formed through the imaging optical system 101 as a real object, and forms again the image onto the image pickup element 103. However, in both of the configurations illustrated in FIGS. 3 and 4, the lens array 102 treats images formed through the imaging optical system 101 as objects, and forms these images on the image pickup element 103, and thus the configurations are essentially the same. Therefore, an argument below is also applicable to the configuration in FIG. 4.

The refocusing, the control of the depth of field, and the change of the image capturing viewpoint are qualitatively the same in the configurations in FIGS. 3 and 4 as in the configuration of FIG. 2. Thus, a description thereof will be omitted below. Pixels having information of an identical region can be selected through Expression (4) and the distance information, as in Embodiment 1.

The flowchart in FIG. 12 illustrates an image processing flow of producing an output image from the input image in Embodiment 2. Since the flow is the same as that in Embodiment 1, a description thereof will be omitted. The image processing apparatus 301 performs operations in the flowchart illustrated in FIG. 12.

The configuration described above can provide the image processing apparatus that employs the image processing method of reducing noise in an image that is obtained by synthesizing parallax images and provided with the control of the depth of field and the change of the image capturing viewpoint.

### Embodiment 3

Next follows a description of Embodiment 3 of an image pickup apparatus that employs the image processing method of the present invention. FIG. 1 illustrates a basic configuration of the image pickup apparatus that employs the image processing method of the present invention. The duplicate descriptions of the same elements as those in Embodiment 1 will be omitted.

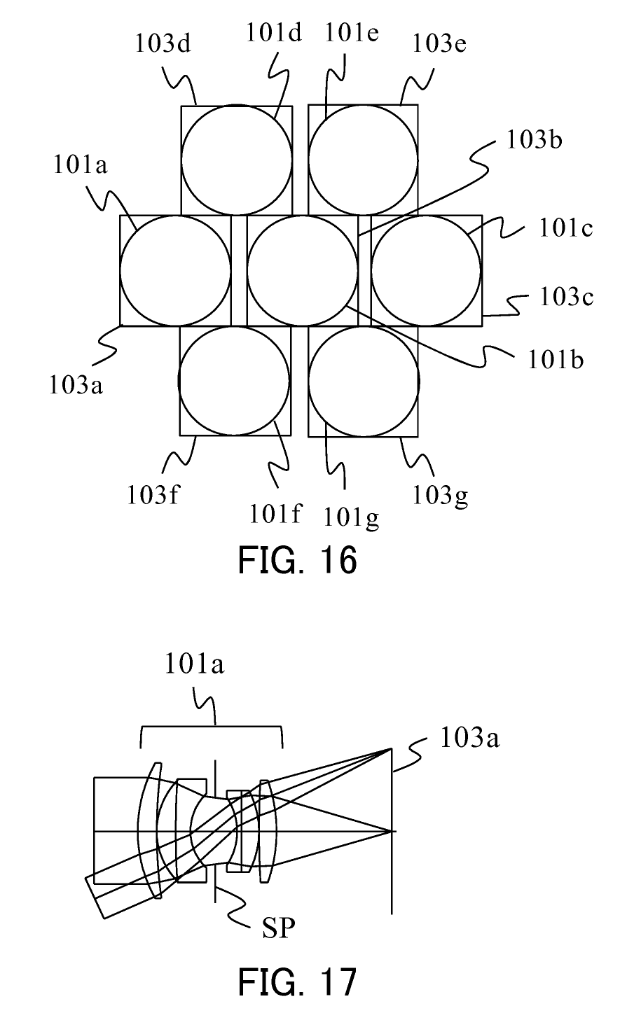

The image pickup optical system 100 in Embodiment 3 has the configuration illustrated in FIG. 5. Imaging optical systems 101a to 101g are two-dimensionally arranged as illustrated in FIG. 16 when viewed from the object side. The imaging optical systems in Embodiment 3 are arranged with a six-fold symmetry with an optical axis of an imaging optical system 101b as a rotation axis. However, the imaging optical systems are not limited to this configuration, and the number of the optical systems and arrangement thereof may be different. Image pickup elements 103a to 103g are arranged closer to the image side than the imaging optical systems 101a to 101g, respectively. However, instead of a plurality of the image pickup elements, any single image pickup element capable of receiving images formed through the imaging optical systems 101a to 101g is applicable. FIG. 5 is a schematic diagram of the image pickup optical system in Embodiment 3 viewed along a section including the optical axis of the imaging optical systems 101a to 101c. Light beams refracted through the imaging optical systems 101a to 101c are received by the corresponding image pickup elements 103a to 103c, respectively. A plurality of images acquired by the image pickup elements 103a to 103c are parallax images (light field) observing the object space at different viewpoints. In Embodiment 3, these parallax images are input as the input image.

FIG. 17 illustrates a detailed cross-sectional view of the imaging optical system 101a and the image pickup element 103a in Embodiment 3. SP denotes an aperture stop. The other imaging optical systems 101b to 101g and and the corresponding image pickup elements 103b to 103g have similar relations. However, the imaging optical systems may have configurations different from one another. The imaging optical system 101a illustrated in FIG. 17 is a single focus lens and performs focusing by entire projection.

The refocusing, the control of the depth of field, and the change of the image capturing viewpoint are qualitatively the same in the configuration in FIG. 5 as in the configuration of FIG. 2, and thus a description thereof will be omitted. The configuration in FIG. 5 differs from that in FIG. 2 in that a pupil reproduced in reconstruction is not the pupil of the imaging optical system 101a but a synthesis pupil obtained by synthesizing the pupil of each imaging optical system.

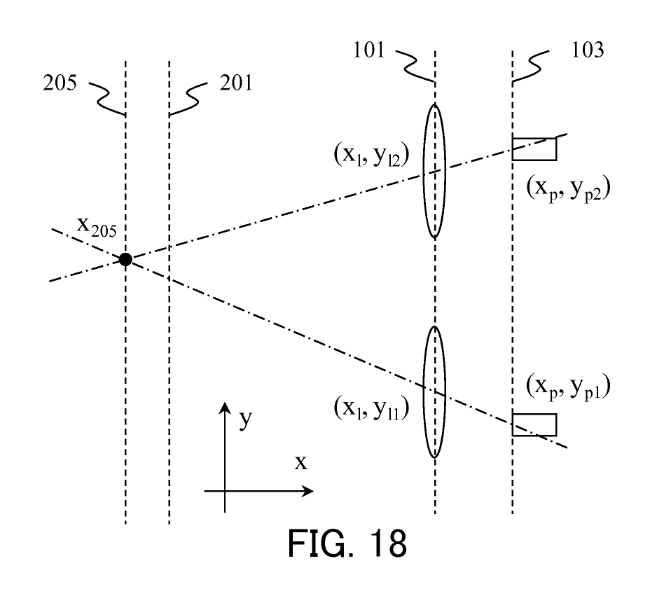

The selection of pixels having information of an identical region is calculated based on the relation in FIG. 18 in a similar manner. In FIG. 18 illustrating two arbitrary pixels that are different from each other, an ellipse represents an arbitrary imaging optical system, a rectangle represents an arbitrary pixel corresponding to the arbitrary imaging optical system, and a dashed line represents a light beam passing through the principal point of the imaging optical system and the center of the pixel. In FIG. 18, (xₗ, yₗᵢ) represents the coordinates of the principal point of the imaging optical system, and (xₚ, yₚᵢ) represents the central coordinates of the pixel. Since the two pixels are at different viewpoints and different from each other, the relation yₗ₁≠yₗ₂ and the relation yₚ₁≠yₚ₂ hold for i=1, 2. The coordinate x₂₀₅ of a plane 205 at which two light beams intersect with each other is written as Expression (5) below.

$${x}_{205} = \frac{{x}_{p} ( {y}_{l 1} - {y}_{l 2} ) - {x}_{l} ( {y}_{p 1} - {y}_{p 2} )}{( {y}_{l 1} - {y}_{ l 2} ) - ( {y}_{p 1} - {y}_{p 2} )} \qquad ( 5 )$$

The plane 205 is at an object distance at which two pixels of interest acquire information of an identical region. For simplification, a two-dimensional coordinate system is assumed, and the principal plane interval of the imaging optical system is ignored. In a real system, Expression (5) may be generalized to a three-dimensional coordinate system. The principal plane interval of the imaging optical system is desirably taken into account in calculation of the distance of the plane 205. Similarly to Embodiment 1, the correspondence of each pixel to an object at an object distance can be determined by obtaining distance information of the object space.

The flowchart in FIG. 12 illustrates an image processing flow of producing an output image (reconstructed image) from the input image in Embodiment 3. Since the flow is the same as that in Embodiment 1, a description thereof will be omitted. The image processor 105 performs operations in the flowchart illustrated in FIG. 12.

The configuration described above can provide the image pickup apparatus that employs the image processing method of reducing noise in an image that is obtained by synthesizing parallax images and provided with the control of the depth of field and the change of the image capturing viewpoint.

The present invention can reduce noise in an image obtained by synthesizing a plurality of parallax images.

The present invention is suitably applicable to an image pickup apparatus such as a compact digital camera, a single-lens reflex camera, and a video camera.

### OTHER EMBODIMENTS

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment (s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-078693, filed on Apr. 7, 2014, which is hereby incorporated by reference herein in its entirety.

What is claimed is:

1. An image processing apparatus configured to provide reconstruction processing on an input image including parallax images of an object space at different viewpoints and to produce a reconstructed image, the image processing apparatus comprising:
a selector configured to select, from the input image, pixels that have information of an identical region of the object space;
a calculator configured to calculate an average signal value based on signal values of the pixels thus selected;
a substitutor configured to substitute signal values of at least one of the pixels with the average signal value;
a producer configured to produce the reconstructed image from the input image including a pixel whose signal value is substituted with the average signal value; and
a determiner configured to determine whether a first depth of field of a synthesized image obtained by synthesizing all parallax images included in the input image with uniform weights is smaller than a second depth of field set to produce the reconstructed image,
wherein the selector selects the pixels when the first depth of field is smaller than the second depth of field.

2. The image processing apparatus according to claim 1, wherein all signal values of pixels that are used to produce the reconstructed image among the pixels are substituted with the average signal value.

3. The image processing apparatus according to claim 1, wherein the average signal value is calculated based on the signal values and weights, and each weight is determined depending on light quantity of each pixel in the pixels.

4. The image processing apparatus according to claim 3, wherein the weight is smaller for a pixel whose light quantity is smaller among the pixels.

5. The image processing apparatus according to claim 1, further comprising:
an image capturing condition information acquirer configured to acquire image capturing condition information when the input image is captured; and
a distance information acquirer configured to acquire distance information of the object space,
wherein the selector selects the pixels based on the image capturing condition information and the distance information.

6. The image processing apparatus according to claim 5, wherein the distance information is calculated based on parallax information of the input image.

7. The image processing apparatus according to claim 1, wherein the reconstructed image is produced based on part of parallax images included in the input image.

8. The image processing apparatus according to claim 1, further comprising a setter configured to set the second depth of field.

9. The image processing apparatus according to claim 8, wherein the second depth of field is set by selecting an f-number.

10. An image pickup apparatus comprising:
an image pickup unit configured to produce an input image including parallax images of an object space at different viewpoints; and
an image processing apparatus configured to provide reconstruction processing on the input image and to produce a reconstructed image,
wherein the image processing apparatus includes:
a selector configured to select, from the input image, pixels that have information of an identical region of the object space;
a calculator configured to calculate an average signal value based on signal values of the pixels thus selected;
a substitutor configured to substitute signal values of at least one of the pixels with the average signal value;
a producer configured to produce the reconstructed image from the input image including a pixel whose signal value is substituted with the average signal value; and
a determiner configured to determine whether a first depth of field of a synthesis image obtained by synthesizing all parallax images included in the input image with uniform weights is smaller than a second depth of field set to produce the reconstructed image,
wherein the selector selects the pixels when the first depth of field is smaller than the second depth of field.

11. The image pickup apparatus according to claim 10, wherein the image pickup unit includes, from an object side,
an imaging optical system configured to image a light beam from an object plane on an image side conjugate plane,
a lens array positioned at the image side conjugate plane, and
an image pickup element including a plurality of pixels,
wherein the lens array enters light beams passing through different regions of a pupil of the imaging optical system into different pixels of the image pickup element.

12. The image pickup apparatus according to claim 10, wherein the image pickup unit includes, from an object side,
an imaging optical system configured to image a light beam from an object plane on an image side conjugate plane,
a lens array, and
an image pickup element including a plurality of pixels,
wherein the lens array is disposed such that the image side conjugate plane and the image pickup element have a conjugate relation, and the lens array enters light beams passing through different regions of a pupil of the imaging optical system into different pixels of the image pickup element.

13. The image pickup apparatus according to claim 10, wherein the image pickup unit includes, from an object side,
a plurality of imaging optical systems configured to image light beams from an object plane on an image side conjugate plane, and
an image pickup element including a plurality of pixels,
wherein the imaging optical systems are two-dimensionally arranged.

14. An image processing method of providing reconstruction processing on an input image including parallax images of an object space at different viewpoints and of producing a reconstructed image, the image processing method comprising the steps of:
selecting, from the input image, pixels that have information of an identical region of the object space;
calculating an average signal value based on signal values of the pixels thus selected;
substituting signal values of at least one of the pixels with the average signal value;
producing the reconstructed image from the input image including a pixel whose signal value is substituted with the average signal value; and
determining whether a first depth of field of a synthesis image obtained by synthesizing all parallax images included in the input image with uniform weights is smaller than a second depth of field set to produce the reconstructed image,
wherein the selecting step selects the pixels when the first depth of field is smaller than the second depth of field.

15. A non-transitory computer-readable storage medium storing a program that causes a computer of an image processing apparatus configured to provide reconstruction processing on an input image including parallax images of an object space at different viewpoints and to produce a reconstructed image, to execute the steps of:
selecting, from the input image, pixels that have information of an identical region of the object space;
calculating an average signal value based on signal values of the pixels thus selected;
substituting signal values of at least one of the pixels with the average signal value;
producing the reconstructed image from the input image including a pixel whose signal value is substituted with the average signal value; and
determining whether a first depth of field of a synthesis image obtained by synthesizing all parallax images included in the input image with uniform weights is smaller than a second depth of field set to produce the reconstructed image,
wherein the selecting step selects the pixels when the first depth of field is smaller than the second depth of field.
